(19) United States
(12) Patent Application Publication
(10) Pub. No.: US 2013/0192237 A1
(43) Pub. Date: Aug. 1, 2013

(54) FUEL INJECTOR SYSTEM WITH FLUIDIC OSCILLATOR

(71) Applicant: Gareth W. Oskam, (US)

(72) Inventor: Gareth W. Oskam, (US)

(73) Assignee: Solar Turbines Inc.

(21) Appl. No.: 13/362,189

(22) Filed: Jan. 31, 2012

(51) Int. Cl. F02C 7/22; F23R 3/28

(52) U.S. Cl. 60/772; 60/740; 60/746

(57) ABSTRACT

A fuel injector system for a turbine engine may include a center body disposed about a longitudinal axis and a barrel housing positioned radially outwardly from the center body to define an annular passageway therebetween. The fuel injector may also include one or more fuel discharge outlets positioned in the annular passageway. The one or more fuel discharge outlets may be configured to discharge pulses of a fuel into the annular passageway. The fuel injector may further include one or more fluidic oscillators fluidly coupled to the one or more fuel discharge outlets. The one or more fluidic oscillators may be configured to induce pulsations in the fuel discharged by the one or more fuel discharge outlets.

### TECHNICAL FIELD

The present disclosure relates generally to a fuel injector system for a turbine engine, and more particularly, to a fuel injector system with a fluidic oscillator.

### BACKGROUND

In a typical gas turbine engine (GTE), one or more fuel injectors direct a fuel into a combustion chamber (called combustor) for combustion. The combustion of hydrocarbon fuels in the combustor produce undesirable exhaust constituents such as NOₓ. Different techniques are used to reduce the amount of NOₓ emitted by GTEs. In one technique, a lean premixed fuel-air mixture is directed to the combustor to burn at a relatively low temperature. A low combustion temperature reduces NOₓ formation. However, combustion in the combustor induces pressure fluctuations within the combustor that may be amplified during operation under lean conditions. These amplified pressure fluctuations may induce mechanical vibrations that can damage the turbine engine.

One method to provide a lean fuel-air mixture to a turbine engine while minimizing the harmful vibrations is described in U.S. Patent Publication No. US 2007/0074518 A1 (“the '518 publication”) assigned to the assignee of the current application. In the '518 publication, the length of different regions of a fuel nozzle are adjusted to generate a pulse in the fuel-air mixture that interferes with the pressure fluctuations in the combustor.

### SUMMARY

In one aspect, a fuel injector system for a turbine engine is disclosed. The fuel injector may include a center body disposed about a longitudinal axis and a barrel housing positioned radially outwardly from the center body to define an annular passageway therebetween. The annular passageway may extend from an upstream end configured to be fluidly coupled to a compressor of the turbine engine to a downstream end configured to be fluidly coupled to a combustor of the turbine engine. The fuel injector may also include one or more fuel discharge outlets positioned in the annular passageway. The one or more fuel discharge outlets may be configured to discharge pulses of a fuel into the annular passageway. The fuel injector may further include one or more fluidic oscillators fluidly coupled to the one or more fuel discharge outlets. The one or more fluidic oscillators may be configured to induce pulsations in the fuel discharged by the one or more fuel discharge outlets.

In another aspect, a method of operating a turbine engine including a fuel injector coupled to a combustor is disclosed. The method may include discharging pulses of a fuel into a compressed air stream flowing through the fuel injector. The fuel pulses may include fuel having a mass that varies periodically. The method may also include mixing the pulses of the fuel with the compressed air to form a fuel-air mixture in which the mass of fuel varies periodically with time. The method may further include delivering the fuel-air mixture to the combustor.

In yet another aspect, a turbine engine is disclosed. The turbine engine may include a compressor fluidly coupled to a combustor, and a plurality of fuel injectors fluidly coupling the compressor and the combustor. The turbine engine may also include one or more fluidic oscillators fluidly coupled to at least one of the plurality of fuel injectors. The one or more fluidic oscillators may be configured to induce pulsations in a fuel directed to the at least one fuel injector. The pulsations in the fuel may include fuel having a mass that varies periodically. The turbine engine may also include one or more fuel discharge outlets coupled to the at least one fuel injector. The one or more fuel discharge outlets may be configured to discharge the fuel from the one or more fluidic oscillators into a compressed air stream flowing towards the combustor.

### BRIEF DESCRIPTION OF THE DRAWINGS

FIG. 1 is a cutaway-view illustration of an exemplary disclosed turbine engine;

FIG. 2 is a cross-sectional illustration of an exemplary fuel injector of the turbine engine of FIG. 1;

FIG. 3 is a pictorial representation of combustion induced pressure waves generated in the turbine engine of FIG. 1; and

FIG. 4 is a schematic representation of an exemplary fluidic oscillator of the turbine engine of FIG. 1;

FIG. 5 is a schematic representation of fuel flow from the fluidic oscillator of FIG. 4; and

FIG. 6 is a schematic representation of an exemplary coupling scheme between the fluidic oscillator and the fuel injector in the turbine engine of FIG. 1.

### DETAILED DESCRIPTION

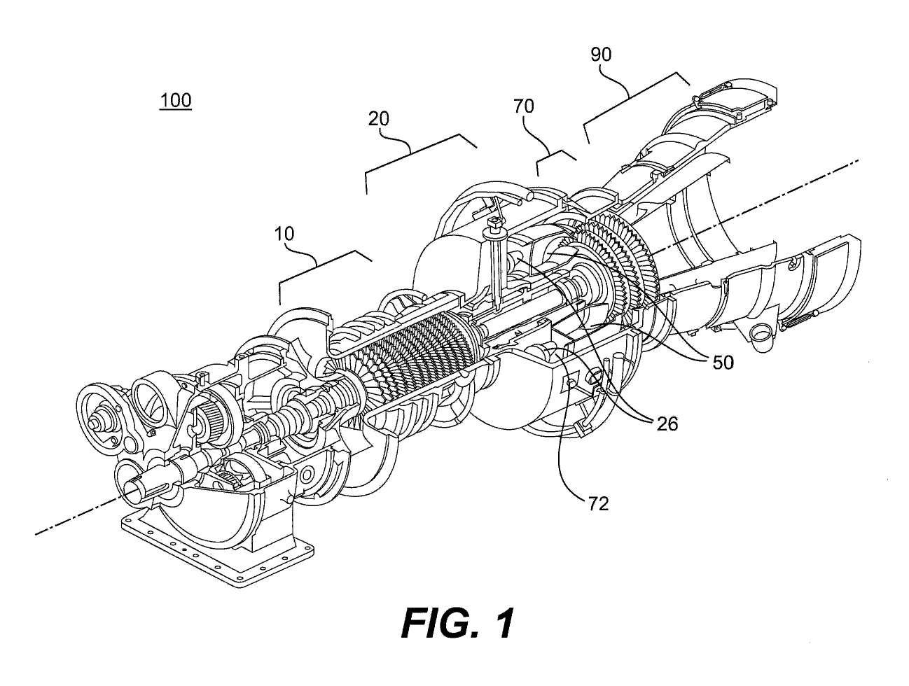

FIG. 1 illustrates an exemplary turbine engine 100 that may be applied in any application. For example, turbine engine 100 may embody a power source of a pump or compressor, a power source of a generator set that produces electrical power output, or a power source associated with an earth-moving machine, a passenger vehicle, a marine vessel, or any other type of machine known in the art. Turbine engine 100 may include a compressor section 10, a combustor section 20, a turbine section 70, and an exhaust section 90. Compressor section 10 compresses inlet air and directs the compressed air to an enclosure 72 of the combustor section 20. Combustor section 20 includes one or more fuel injectors 26 that mix a fuel with the compressed air and directs the fuel-air mixture to a combustor 50 for combustion. Combustion of the fuel-air mixture produces combustion gases at a high pressure and temperature. These combustion gases are directed to the turbine section 70 which extracts energy from these combustion gases, and directs the spent exhaust gases to the atmosphere through exhaust section 90. The layout of GTE 100 illustrated in FIG. 1, and described above, is only exemplary, and fuel injectors 26 of the current disclosure may be used with any configuration and layout of GTE 100.

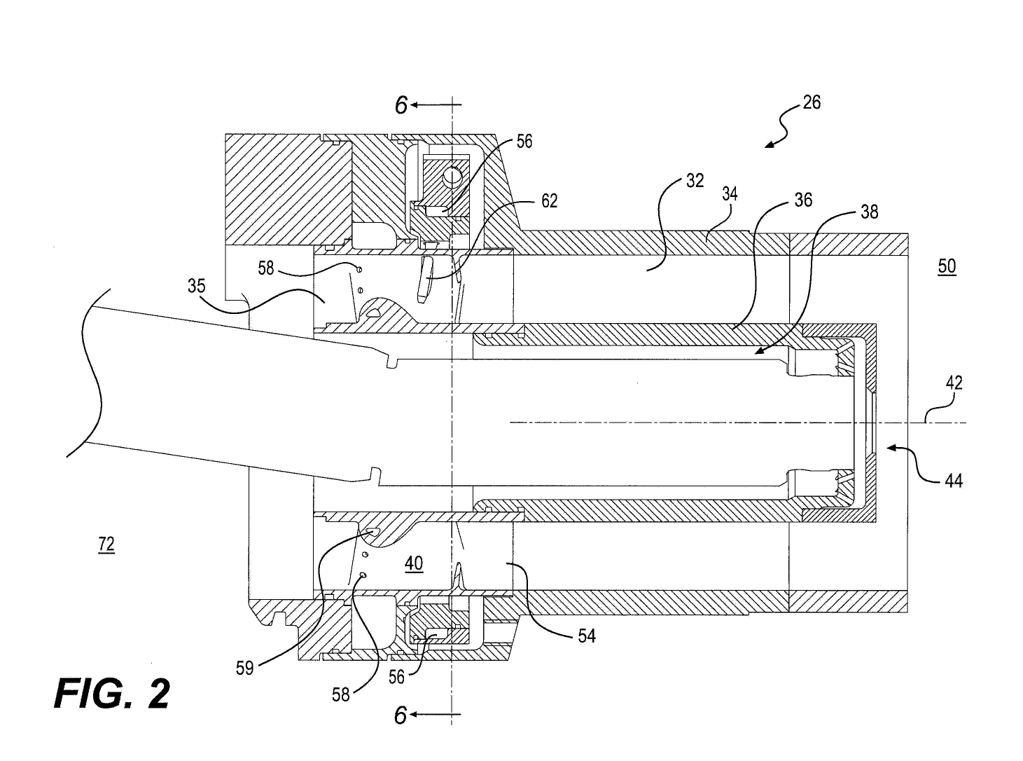

FIG. 2 illustrates a cross-sectional view of an exemplary fuel injector 26 that may be used in GTE 100 of FIG. 1. Fuel injector 26 includes a barrel housing 34 connected at one end to an inlet duct 35 and at an opposing end to the combustor 50 (see FIG. 1). An upstream end of the inlet duct 35 is fluidly coupled to the enclosure 72, and a downstream end of the inlet duct 35 is fluidly coupled to the barrel housing 34. Fuel injector 26 may also include a center body 36 enclosing a pilot assembly 38. Center body 36 may be disposed radially inwardly of barrel housing 34 and aligned along a longitudinal axis 42 of the fuel injector 26. The pilot assembly 38 may be located within the center body 36 and configured to inject a stream of pressurized fuel and compressed air through a tip end 44 of the center body 36 into the combustor 50. The stream of fuel and air from the pilot assembly 38 may facilitate engine starting, idling, cold operation, and/or lean burn operations of GTE 100.

An annular passageway 32 may be defined between the barrel housing 34 and the center body 36. Although passageway 32 is described as being annular, it is contemplated that passageway 32 may, in general, have any shape (for example, rectangular), and be any type of mixing duct that houses any style of aerodynamic mixing (free vortex, forced vortex, hybrid vortex, or another type of mixing) The annular passageway 32 receives a fuel-air mixture from the inlet duct 35 and discharges the fuel-air mixture into the combustor 50. The inlet duct 35 receives compressed air from the enclosure 72 at the upstream end, mixes the compressed air with fuel, and discharges the fuel-air mixture into the annular passageway 32 at the downstream end. In some embodiments, an air restriction device, such as a blocker ring (not shown) may be positioned at the upstream end of the inlet duct 35 to control the amount of air that enters the fuel injector 26 from the enclosure 72.

An air swirler 40 is annularly disposed between the center body 36 and the inlet duct 35 in the path of the compressed air flowing through the inlet duct 35. The air swirler 40 may include an annulus with a plurality of vanes 54 connected thereto. As the compressed air flows across the vanes 54, a rotational component of velocity may be imparted to the compressed air. The inlet duct 35 may also include fuel inlet ports configured to direct a fuel into the air stream flowing through the inlet duct 35. In some embodiments, these fuel inlet ports may be coupled to the air swirler 40. For instance, in some embodiments, some or all of the vanes 54 of the air swirler 40 may include a plurality of gaseous fuel orifices 58 provided thereon. In some embodiments, these orifices 58 may be provided at the upstream side (or the leading edge) of the vanes 54. The number and arrangement of the orifices 58 in a vane 54 may depend upon the application. These orifices 58 may direct a gaseous fuel into the air stream flowing in the inlet duct 35. Any type of gaseous fuel, such as, for example, natural gas, landfill gas, bio-gas, or any other suitable gaseous fuel may be directed into the fuel injector 26 through the orifices 58. The orifices 58 may be in communication with a gaseous fuel gallery 59 annularly positioned about the fuel injector 26. The gaseous fuel gallery 59 may receive the gaseous fuel from an external source (not shown). As the fuel enters the inlet duct 35 through the orifices 58, the fuel mixes with the compressed air flowing across the air swirler 40 to form a fuel-air mixture. This fuel-air mixture enters the combustor 50 through the annular passageway 32.

In embodiments where the fuel injector 26 is configured to operate on both a liquid fuel and a gaseous fuel (that is, a dual fuel injector), the inlet duct 35 may also be configured to direct a liquid fuel into the air stream flowing through the inlet duct 35. In such embodiments, one or more liquid fuel lines may direct the liquid fuel to a liquid fuel gallery 56 annularly positioned about the fuel injector. One or more liquid fuel nozzles or spokes 62 may inject the liquid fuel in the liquid fuel gallery 56 into the air stream in the inlet duct 35. In general, the spokes 62 may be symmetrically positioned about the longitudinal axis 42 of the fuel injector 26. In some embodiments, the spokes 62 may be coupled to the vanes 54 of the air swirler 40. The number of spokes 62 may depend upon the application. In some embodiments, a spoke 62 may be coupled to every vane 54, while in other embodiments, a spoke 62 may be coupled to every alternate vane 54 or another numerical sequence.

Combustor 50 is configured to receive the fuel-air mixture through the annular passageway 32 of each fuel injector 26. This fuel-air mixture ignites and is combusted in the combustor 50. As the fuel-air mixture combusts, an expanding flame front is created. Due to the variations in the fuel-air mixture directed to the combustor 50 through different fuel injectors 26, circumferential pressure fluctuations may be induced in the combustor 50. These pressure fluctuations emanate from the flame front and propagate as a sinusoidal pressure wave into the fuel injectors 26 against the flow of the fuel-air mixture. In general, the frequency of the pressure wave depends on the application (such as, for example, the geometry of the combustor, etc.). These combustion induced pressure waves may affect the flow of fuel entering the fuel injector 26.

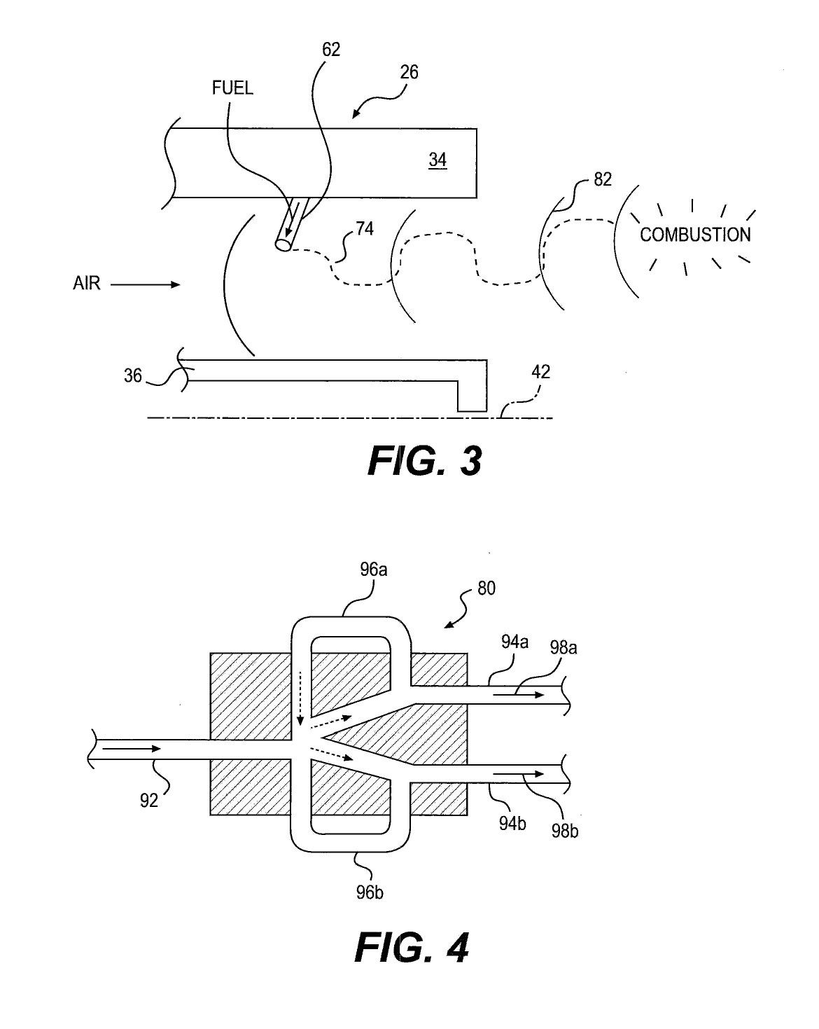

FIG. 3 illustrates the effect of a combustion induced pressure wave 82 on the flow characteristics of the liquid fuel in the fuel injector 26. As the pressure wave 82 moves past the outlet of a spoke 62, the mass flow of liquid fuel exiting the spoke 62 changes. As a peak of the sinusoidal pressure wave 82 reaches the spoke 62, the mass flow of the fuel exiting the spoke 62 decreases. And, as a valley of the sinusoidal pressure wave reaches the spoke 62, the mass flow increases. Thus, because of the combustion induced pressure wave 82 in the combustor 50, the mass of liquid fuel exiting the spoke 62 varies periodically at a frequency substantially equal to the frequency of the pressure wave 82. The liquid fuel exiting the spoke 62 mixes with the air flowing past the spoke 62 to form a liquid fuel-air mixture. Fuel-air curve 74 represents the time-varying mass flow of the liquid fuel-air mixture through the fuel injector 26. As a result of the pressure wave 82, the mass flow of the fuel-air mixture reaching the combustor 50 varies in a periodic manner with time. When the mass flow of the fuel-air mixture reaching the combustor 50 is high (compared to a time averaged value), the heat release and the resulting pressure wave 82 generated in the combustor 50 may be high. Likewise, when the mass flow is low, the heat release and resulting pressure wave 82 within the combustor 50 may be low. Thus, the fuel pulses that are induced by the pressure waves 82 interact with the pressure waves 82 generated in the combustor 50. Since the fuel pulses have substantially the same frequency as the pressure waves 82, these fuel pulses may amplify and exacerbate the pressure waves 82 in the combustor 50.

Although pulsations in the liquid fuel flow into the annular passageway 32 through spoke 62 is discussed herein, it should be noted that this is only exemplary. In general, the pressure waves 82 may cause pulsations or fluctuations in the flow of any type of fuel into the fuel injector 26. And, these pulsations in the fuel flow may impact the pressure waves 82 in the combustor in a manner similar to that discussed above. For example, the pressure waves 82 may induce pulsations in the gaseous fuel flow into the fuel injector 26 through orifice 58, and these gaseous fuel pulsations may reinforce the pressure waves 82 in combustor 50 a manner similar to that discussed above. Depending upon the design of fuel injector 26, in some embodiments, the pressure waves 82 may also cause pulsations (or other detrimental effects) in the fuel flow into the pilot assembly 38 in a similar manner For the sake of brevity, only the effect of the pressure wave 82 on the liquid fuel flow into the annular passageway 32 through spoke 62 is discussed herein.

If the frequency of the fuel pulses from spoke 62 (or as discussed above, the orifice 58, or the liquid or gaseous fuel flow into the pilot assembly 38) is different from the frequency of the pressure wave 82, the resulting fuel-air curve 74 may interfere with and damp the pressure waves 82 generated in the combustor 50. The amount of damping may depend upon (among other factors) the phase difference between the fuel-air curve 74 and the pressure wave 82. For example, in some cases, a fuel-air curve 74 that is 180° out of phase with the pressure wave 82 may provide maximum damping. Depending upon fuel injector design, in some embodiments, the mechanism by which a fuel pulse out of phase with the pressure wave 82 (that is, a fuel pulse that is at a frequency different from the pressure wave 82) diminishes the effect the pressure wave 82 may be different. For example, in some embodiments, pulsations in the liquid fuel flow into the pilot assembly 38 may impact the pressure wave 82 in a different manner. In some embodiments, the oscillating pressure wave 82 may affect the break-up, evaporation, and subsequent combustion of droplets of the liquid fuel sprayed into the combustor 50 from the pilot assembly 38. The evaporation is affected by changes in mass transfer characteristics between the fuel drop and the surrounding gases and the combustion is affected by changes in the oxidant mass fraction as the pressure wave first increases the mass fraction and then reduces it. Imposing a pulsation in the liquid fuel flow that is out of phase with the pressure wave 82 will interrupt the cycle and diminish the detrimental effects of the pressure wave 82.

Pulsation in the fuel flow may be induced by introducing pulsations or variations in the fuel supply to the fuel injector 26. For instance, directing pulses of fuel at a certain frequency into the fuel injector 26 may introduce pulsations in the fuel flow at that frequency in the fuel injector 26. In some embodiments, a device, such as, for example, a fluidic oscillator, configured to induce pulsations in the fuel flow may be coupled to a fuel line that delivers a fuel into the fuel injector 26. Fluidic Oscillators are devices with no moving parts that generate an oscillating jet of fluid at high frequencies. The oscillating jet of fluid is created by fluid-dynamic instabilities within the device.

FIG. 4 is a schematic illustration of an exemplary fluidic oscillator 80 that may be fluidly coupled to the liquid fuel lines of the fuel injector 26. The liquid fuel lines may include a fuel input line 92 that directs the liquid fuel at pressure into the fluidic oscillator 80, and fuel output lines 94a and 94b that direct the liquid fuel from the fluidic oscillator 80 to the fuel injector 26. Fluidic oscillator 80 generates an oscillating jet of liquid fuel through fuel output lines 94a and 94b when supplied with liquid fuel at pressure through fuel input line 92. Since, fluidic oscillator 80 has no moving parts, as compared to devices such as valves etc., the reliability and life expectancy of the fluidic oscillator 80 is expected to be significantly higher.

Within the fluidic oscillator 80, liquid fuel from fuel input line 92 initially flows through both the fuel output lines 94a and 94b. Obstructions in the flow path (such as, for example, the obstruction caused due to the branching of the fuel input line 92 into the two fuel output lines 94a and 94b) introduces turbulence in the liquid flow, and causes the liquid stream to bend (or be diverted) to one side and flow through one of the two fuel output lines 94a or 94b, for example, fuel output line 94a. A part of the liquid flowing through fuel output line 94a recirculates through bypass line 96a and impinges on the liquid stream entering the fuel output line 94a. The force of the impinging jet causes the liquid stream to bend in the opposite direction and enter fuel output line 94b. A part of the liquid in fuel output line 94b recirculates through bypass line 96b and impinges on the liquid stream entering the fuel output line 94b, causing the liquid stream to again flow through fuel output line 94a. Thus, the fluidic oscillator 80 generates a pulsating jet of liquid fuel (98a, 98b) that oscillates (or alternates) between fuel output lines 94a and 94b when supplied with liquid fuel through fuel input line 92.

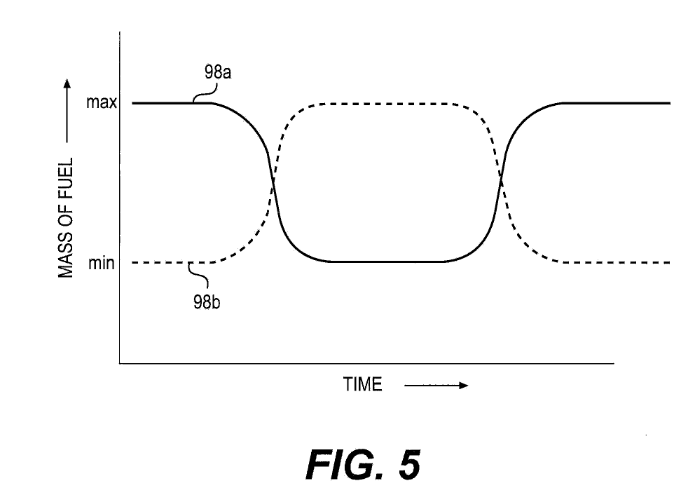

FIG. 5 is a schematic illustration of the pulsating jets 98a, 98b of liquid fuel through the fuel output lines 94a and 94b. The pulsating jets 98a, 98b may include liquid fuel having a mass that varies periodically (such as, for example, as a smooth step function or a smooth sawtooth function, etc.) from a minimum mass (such as, for example, from a mass of substantially zero) to a maximum mass at a frequency. Since the liquid fuel oscillates between fuel output lines 94a and 94b, a phase difference exists between the fuel pulses in fuel output lines 94a and 94b (that is, pulsating jets 98a, 98b). That is, when the mass of fuel in pulsating jet 98a is at a maximum, the mass of fuel in pulsating jet 98b will be at a minimum. The frequency of the pulsations depend upon the design of the fluidic oscillator 80 (geometry of obstruction, shape and size of fluid flow paths, etc.) and the characteristics of the liquid flow (pressure, volume, etc.). In an application, the geometry of the fluidic oscillator 80 and/or the characteristic of the fuel flow may be selected to generate fuel pulses having a desired frequency (such as, for example, a frequency that will damp pressure waves 82 sufficiently). In some embodiments, multiple fluidic oscillators 80 may be coupled to the fuel lines to direct fuel pulses having a desired frequency to the fuel injector 26. It should be noted that the structure of the fluidic oscillator 80 illustrated in FIG. 4 is exemplary only, and any fluidic oscillator 80 configured to generate pulsating jets 98a, 98b of fuel through fuel output lines 94a and 94b may be coupled to fuel injector 26.

The pulsating jets 98a, 98b of liquid fuel through fuel output lines 94a and 94b may be directed to the fuel injector 26 in any manner. In some embodiments, the two fuel output lines 94a and 94b may direct liquid fuel to different fuel injectors 26 of the turbine engine 100. In such embodiments, the fuel output lines 94a and 94b may be coupled to different fuel injectors 26 such that the phase difference between the fuel pulses in fuel output lines 94a and 94b reduces, or beneficially impacts, the combustion induced pressure waves 82 in the combustor 50. The pulsations in the liquid fuel through each of the fuel output lines 94a and 94b may also interfere with and damp the pressure waves 82 in the combustor 50. In some embodiments, the two fuel output lines 94a and 94b may direct liquid fuel to the same fuel injector 26 such that a phase difference, or a time lag, is introduced between the fuel pulses emanating from different spokes 62 of the fuel injector 26.

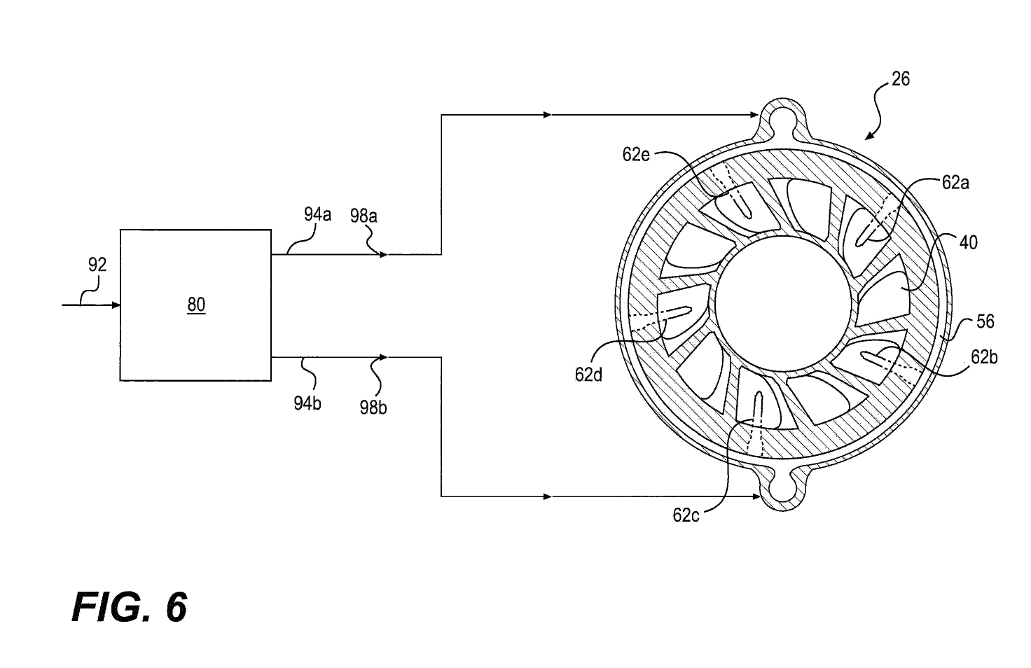

FIG. 6 is a schematic illustration of a fluidic oscillator 80 coupled to a fuel injector 26. Note that some components of the fuel injector 26 have been removed in FIG. 6 for clarity. The fuel output lines 94a, 94b may be fluidly coupled to the liquid fuel gallery 56 such that liquid fuel is introduced into the liquid fuel gallery 56 at different locations. For instance, in an exemplary embodiment, as illustrated in FIG. 6, fuel output lines 94a and 94b may be fluidly coupled to the liquid fuel gallery 56 180° apart from each other. In this configuration, fuel output line 94a (that is, the outlet of fuel output line 94a into liquid fuel gallery 56) is located proximate some spokes 62 (for example, spokes 62a and 62e) and fuel output line 94b is located proximate other spokes 62 (for example, spokes 62b, 62c). As explained previously, there is a phase difference (or a time lag) between the pulses of fuel entering the liquid fuel gallery 56 through the two fuel output lines 94a, 94b. Therefore, because of differences in the distance of each spoke 62 from the fuel output lines 94a, 94b, there will exist a phase difference between the fuel pulses exiting each spoke 62. In addition to the damping effect of the fuel pulses from each spoke 62 on the pressure wave 82 in the combustor 50, the time lag in the fuel pulses through different spokes 62 may interfere with and further damp the pressure wave 82. It should be noted that an angular spacing of 180° between the fuel output lines 94a and 94b is only exemplary. In general, the angular spacing between the fuel output lines 94a, 94b may be selected such that the phase difference between the fuel pulses through different spokes 62 reduces, or beneficially impacts, the combustion induced pressure waves 82 in the combustor 50.

In some embodiments, multiple fluidic oscillators 80 may be coupled to the fuel lines that direct fuel to a fuel injector 26 (or multiple fuel injectors 26) of a turbine engine 100. The multiple fluidic oscillators 80 may be arranged to achieve a desired frequency of the fuel pulses and/or a desired phase difference between the fuel pulses through different spokes 62. Although the fluidic oscillator 80 discussed above is coupled to the liquid fuel lines of the fuel injector 26, additionally or alternatively, fluidic oscillators 80 may also be coupled to the gaseous fuel lines of the fuel injector 26. It should also be noted that, although the fluidic oscillator 80 is described as being separate from the fuel injector 26, in some embodiments, the fluidic oscillator 80 may be integrated with, and be a part of, the fuel injector 26.

### INDUSTRIAL APPLICABILITY

The disclosed fuel injector may be applicable to any turbine engine where reduced combustion induced oscillations are desired. Although particularly useful for low NOₓ emitting turbine engines, the disclosed fuel injector may be applicable to any turbine engine regardless of the emission output of the engine. The disclosed fuel injector may reduce combustion induced oscillations by inducing pulsations in the fuel flow into the fuel injector using a fluidic oscillator. The operation of the fuel injector will now be explained.

During operation of GTE 100, fuel (liquid and/or gaseous fuel) may be directed into a combustor 50 through a plurality of fuel injectors 26. One or more fluidic oscillators 80 may be fluidly coupled to the fuel lines that direct the fuel to the fuel injectors 26 to impart pulsations having a desired frequency to the fuel. The pulsations in the fuel flow causes sinusoidal variations in the mass of fuel directed to the combustor 50. These pulsations in the fuel flow interfere with and damp the combustion induced oscillations generated in the combustor 50. Since the pulsations in the fuel flow are generated using a device that does not include moving parts, the reliability of the fuel injector 26 and the gas turbine engine is improved.

It will be apparent to those skilled in the art that various modifications and variations can be made to the disclosed fuel injector. Other embodiments will be apparent to those skilled in the art from consideration of the specification and practice of the disclosed fuel injector. It is intended that the specification and examples be considered as exemplary only, with a true scope being indicated by the following claims and their equivalents.

What is claimed is:

1. A fuel injector system for a turbine engine, comprising:
a center body disposed about a longitudinal axis;
a barrel housing positioned radially outwardly from the center body to define an annular passageway therebetween, the annular passageway extending from an upstream end configured to be fluidly coupled to a compressor of the turbine engine to a downstream end configured to be fluidly coupled to a combustor of the turbine engine;
one or more fuel discharge outlets positioned in the annular passageway, the one or more fuel discharge outlets being configured to discharge pulses of a fuel into the annular passageway; and
one or more fluidic oscillators fluidly coupled to the one or more fuel discharge outlets, the one or more fluidic oscillators being configured to induce pulsations in the fuel discharged by the one or more fuel discharge outlets.

2. The fuel injector system of claim 1, wherein the pulses of the fuel include fuel having a mass that varies periodically at a selected frequency.

3. The fuel injector system of claim 1, wherein the fuel is a gaseous fuel.

4. The fuel injector system of claim 1, wherein the fuel is a liquid fuel.

5. The fuel injector system of claim 1, wherein the one or more fuel discharge outlets includes a plurality of fuel discharge outlets, wherein each fuel discharge outlet of the plurality of fuel discharge outlets is configured to discharge fuel pulses having a phase difference with fuel pulses discharged by another fuel discharge outlet of the plurality of fuel discharge outlets.

6. The fuel injector system of claim 1, wherein the one or more fluidic oscillators are configured to discharge pulses of a fuel through the one or more fuel discharge outlets at a frequency selected to damp combustion induced pressure waves in the combustor.

7. The fuel injector system of claim 1, wherein the one or more fluidic oscillators are integral with, and form part of, the fuel injector.

8. The fuel injector system of claim 1, further including a fuel gallery annularly positioned about the fuel injector, the one or more fluidic oscillators being fluidly coupled to the one or more fuel discharge outlets through the fuel gallery.

9. The fuel injector system of claim 8, further including a plurality of fuel output lines that direct the fuel from the one or more fluidic oscillators to the fuel gallery, wherein outlets of the fuel output lines into the fuel gallery are angularly spaced apart from each other.

10. A method of operating a turbine engine including a fuel injector coupled to a combustor, comprising:
discharging pulses of a fuel into a compressed air stream flowing through the fuel injector, wherein the fuel pulses include fuel having a mass that varies periodically; and
mixing the pulses of the fuel with the compressed air to form a fuel-air mixture in which the mass of fuel varies periodically with time; and
delivering the fuel-air mixture to the combustor.

11. The method of claim 10, further including generating the pulses of the fuel using a fluidic oscillator.

12. The method of claim 11, further including directing the generated pulses of the fuel to a fuel gallery of the fuel injector prior to the discharging.

13. The method of claim 12, wherein discharging pulses of the fuel includes discharging the pulses through a plurality of fuel discharge outlets symmetrically positioned about the fuel injector, wherein the pulses of the fuel discharged by a fuel discharge outlet of the plurality of fuel discharge outlets includes a phase difference with the pulses of fuel discharged by another fuel discharge outlet of the plurality of fuel discharge outlets.

14. The method of claim 10, wherein discharging pulses of the fuel includes discharging the pulses through a plurality of fuel discharge outlets symmetrically positioned about the fuel injector, wherein the pulses of the fuel discharged by a fuel discharge outlet of the plurality of fuel discharge outlets includes a same phase as the pulses of fuel discharged by the other fuel discharge outlets of the plurality of fuel discharge outlets.

15. The method of claim 10, wherein discharging pulses of the fuel includes discharging pulses of a gaseous fuel into the compressed air stream

16. The method of claim 10, wherein discharging pulses of the fuel includes discharging pulses of a liquid fuel into the compressed air stream.

17. A gas turbine engine, comprising:
a compressor fluidly coupled to a combustor;
a plurality of fuel injectors fluidly coupling the compressor and the combustor;
one or more fluidic oscillators fluidly coupled to at least one of the plurality of fuel injectors, the one or more fluidic oscillators being configured to induce pulsations in a fuel directed to the at least one fuel injector, wherein the pulsations in the fuel include fuel having a mass that varies periodically; and
one or more fuel discharge outlets coupled to the at least one fuel injector, the one or more fuel discharge outlets being configured to discharge the fuel from the one or more fluidic oscillators into a compressed air stream flowing towards the combustor.

18. The gas turbine engine of claim 17, wherein the one or more fuel discharge outlets include a plurality of fuel discharge outlets positioned symmetrically about the fuel injector, wherein each fuel discharge outlet of the plurality of fuel discharge outlets is configured to discharge pulses of fuel having a phase difference with pulses of fuel discharged by another fuel discharge outlet of the plurality of fuel discharge outlets.

19. The gas turbine engine of claim 17, wherein the fuel is a gaseous fuel.

20. The gas turbine engine of claim 17, wherein the one or more fluidic oscillators are configured to induce pulsations in the fuel at a frequency selected to damp combustion induced pressure waves in the combustor.
